(19) United States
(12) Patent Application Publication
(10) Pub. No.: US 2008/0315620 A1
(43) Pub. Date: Dec. 25, 2008

(54) Auto Panel Attachment Device

(75) Inventors: James O. Campbell, JR., Sterling Heights, MI (US); Dave Gunthner, Clinton Twp., MI (US); Sreedhar K. Mogulluri, Pune (IN); Sandeep Jadhav, Pune (IN)

Correspondence Address: GIBSON & DERNIER L.L.P., 900 ROUTE 9 NORTH, SUITE 504, WOODBRIDGE, NJ, 07095, US

(73) Assignee: FAURECUA INTERIOR SYSTEMS U.S.A., INC., Auburn Hills, MI (US)

(21) Appl. No.: 11/767,758

(22) Filed: Jun. 25, 2007

(51) Int. Cl. B60J 5/00

(52) U.S. Cl. 296/146.7

(57) ABSTRACT

A fastening mechanism for coupling a trim panel to a door module is disclosed, wherein the mechanism may include a hook disposed on a first mating surface of one of the door panel and the door module, the hook including a V-shaped neck extending away from the first mating surface, the neck including a first bearing surface directed substantially toward the first mating surface and an engaging element disposed at a distal end of the neck; and a receiver disposed on a second mating surface of the other of the door panel and the door module, the receiver including a V-shaped slot operable to receive the V-shaped neck of the hook and a second bearing surface operable to engage the first bearing surface of the hook and to prevent separation of the first and second mating surfaces.

### BACKGROUND OF THE INVENTION

The present invention relates in general to components for assembly in an automobile body, and in particular to devices for fastening interior door trims to a door module.

Typically, automotive door modules are constructed from metal or plastic and form part of the load bearing structure of an automobile door. Interior door panels, or trim panels, are commonly affixed to such door modules to provide an interior surface that is aesthetically pleasing and pleasant to the touch. Typically the main mating surfaces of the trim panel and the door module engage one another at a mating interface. Attachment means, such as basic hook/receiver components, may be provided on one or both of the trim panel and the door module to enable a secure connection between the two parts at a bearing interface.

Existing bearing interfaces provide the basic ability to connect a trim panel to a door module. However, the integrity of this connection may be susceptible to deterioration over time due dimensioning tolerances of the respective parts, vibration of the automobile, and/or deformation of the parts over time. Accordingly, there is a need in the art for device for fastening a trim panel to a door module that provides improved connection integrity while also providing means for simple and inexpensive assembly.

### SUMMARY OF THE INVENTION

According to one aspect, the invention is directed to a fastening mechanism for coupling a trim panel to a door module that may include a hook disposed on a first mating surface of one of the door panel and the door module, the hook including a V-shaped neck extending away from the first mating surface, and an engaging element disposed at a distal end of the neck, the engaging element including a first bearing surface directed substantially toward the first mating surface; and a receiver disposed on a second mating surface of the other of the door panel and the door module, the receiver including a V-shaped slot operable to receive the V-shaped neck of the hook and a second bearing surface operable to engage the first bearing surface of the hook and to prevent separation of the first and second mating surfaces.

According another aspect, the invention is directed to a fastening mechanism for coupling a trim panel to a door module, that may include a hook disposed on a first mating surface of one of the door panel and the door module, the hook including a neck extending away from the first mating surface and an engaging element disposed at a distal end of the neck, the engaging element including a first bearing surface directed substantially toward the first mating surface and a tension element springingly extending from the first bearing surface; and a receiver disposed on a second mating surface of the other of the door panel and the door module, the receiver including a second bearing surface directed substantially toward the second mating surface and being operable to engage the first bearing surface of the hook.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1A is a schematic side view of the attachment of a trim panel to a door module using one or more fastening devices in accordance with one or more embodiments of the present invention;

FIG. 1B is an expanded view of a fastening device of FIG. 1;

FIG. 2A is a perspective view of a fastening device in accordance with one or more embodiments of the present invention;

FIG. 2B is a partially sectional and partially elevational view of the fastening device of FIG. 2A;

FIG. 3 is a perspective view of a receiver portion of the fastening device of FIG. 2;

FIG. 4 is a perspective view of a hook portion of the fastening device of FIG. 2;

FIG. 5A is a perspective view of a fastening device in accordance with one or more embodiments of the present invention;

FIG. 5B is a partially sectional and partially elevational view of the fastening device of FIG. 5A;

FIG. 6 is a perspective view of a receiver portion of the fastening device of FIG. 5; and

FIG. 7 is a perspective view of a hook portion of the fastening device of FIG. 5.

### DETAILED DESCRIPTION OF THE PREFERRED EMBODIMENTS

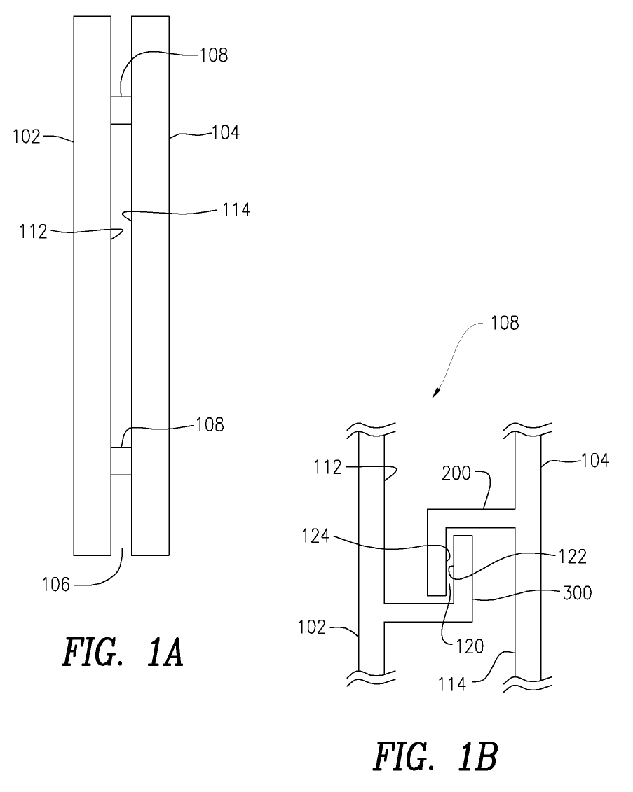

FIG. 1A is a schematic side view of the attachment of a trim panel 104 to a door module 102 using one or more fastening devices 108 in accordance with one or more embodiments of the present invention. FIG. 1B is an expanded schematic view of the fastening device 108 of FIG. 1A.

The assembly of FIG. 1A may include mating interface 106 between the mating surface 114 of trim panel 104 and mating surface 112 of door module 102. Each fastening device 108 may include a hook 200 and a receiver 300. Hook 200 and receiver 300 may include bearing surfaces 124 and 122, respectively, which may contact one another at bearing interface 120. While FIG. 1B shows hook 200 connected to trim panel 104 and receiver 300 connected to door module 300, it will be appreciated by those of ordinary skill in the art that, in other embodiments, hook 200 could be connected to either of trim panel 104 or door module 102, and receiver 300 could be connected to the other of trim panel 104 and door module 102.

The following discussion is directed to embodiments of fastening device 108 having bearing interfaces 106 that are operable to provide ease of assembly of the hook 200 and receiver 300, mechanical integrity of the connection between hook 200 and receiver 300 over time even with the presence of variation in part dimensions, vehicle vibration, and/or deformation of the constituent parts of fastening device 108 over time.

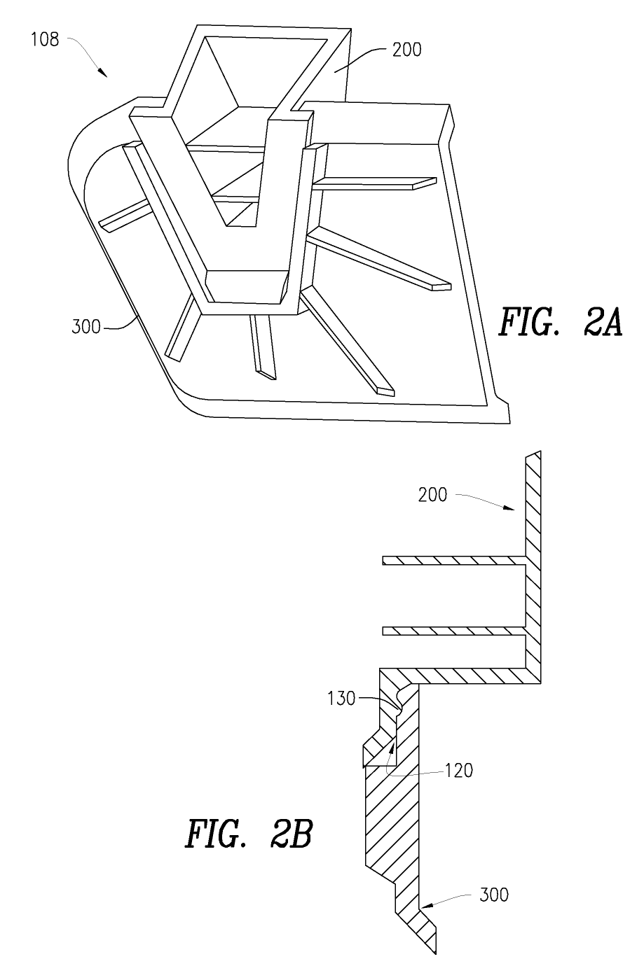

FIG. 2A is a perspective view of a fastening device 108 in accordance with one or more embodiments of the present invention; and FIG. 2B is a partially sectional and partially elevational view of the fastening device 108 of FIG. 2A. Fastening device 108 may include hook 200 and receiver 300, which may engage one another at bearing interface 120. Fastening device 108 may further include detent mechanism 130 (FIG. 2B) to aid in securing hook 200 to receiver 300. Detent mechanism 130 may include a protrusion deployed on one of hook 200 and receiver 300 and a corresponding recess deployed on the other of hook 200 and receiver 300. Various features of hook 200 and receiver 300 that enable the desired means of assembly thereof and the desired operation of fastening device 108 are discussed in the following.

In the following, the various parts of hook 200 and receiver 300 are introduced. Thereafter, a selection of the parts are described in greater detail. Subsequently, a description of the interaction of various features of the hook 200 and receiver 300 during assembly of fastening device 108 is provided.

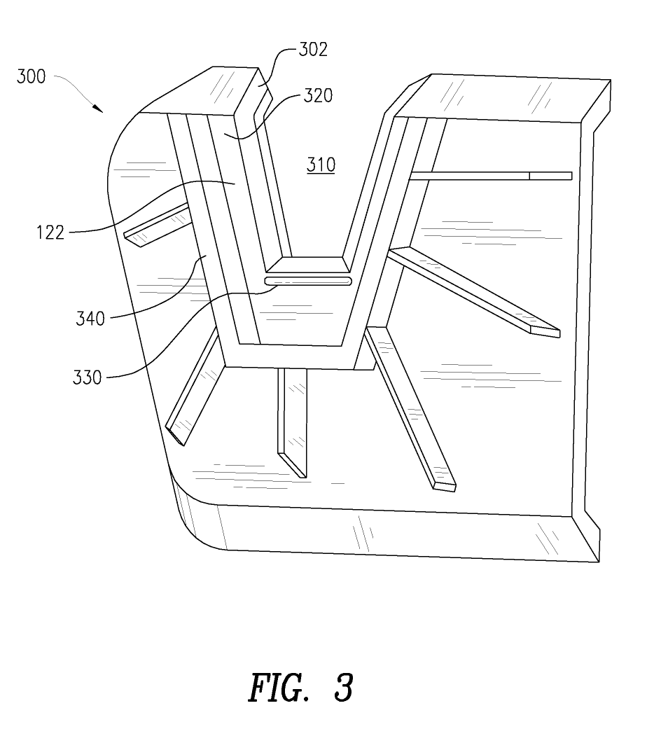

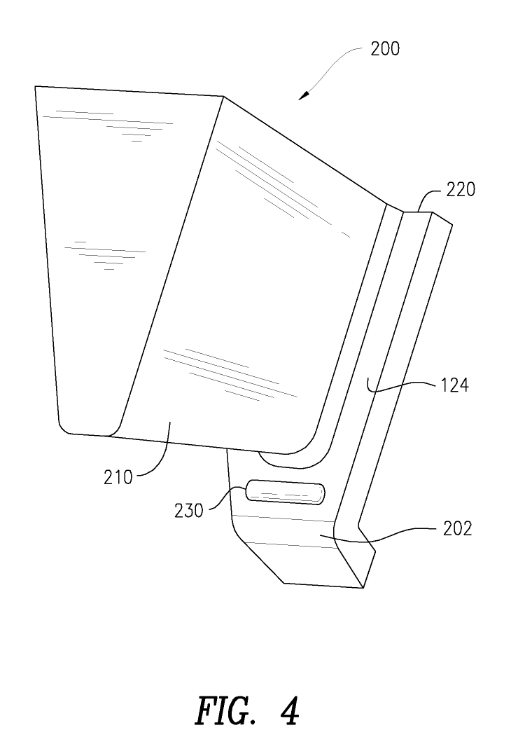

FIG. 3 is a perspective view of a receiver 300 portion of the fastening device 108 of FIG. 2. Receiver 300 may include one or more chamfered flanges 302, bearing surface 122, slot 310 (which may be V-shaped), notch 320 (which may be V-shaped), recess 330, and engagement ridge 340. FIG. 4 is a perspective view of a hook 200 portion of the fastening device 108 of FIG. 2. Hook 200 may include neck 210 and engaging element 220, which may in turn include locking element 230, one or more chamfered flanges 202, and bearing surface 124.

Directing attention to receiver 300, slot 310 and notch 320 and may be V-shaped to accommodate a V-shaped neck 210 of hook 200. However, slot 310 and notch 320 are not limited to be being V-shaped, and may assume any one of a number of shapes, including but not limited to, rectangular, square, semi-circular, and oval. Notch 320 preferably includes bearing surface 122 which may be operable to engage bearing surface 124 of hook 200. Recess 330 may a slot, or other opening for receiving a corresponding locking element 230 on hook 200. Recess 320 preferably forms part of detent mechanism 130.

Directing attention to hook 200 of FIG. 4, neck 210 preferably extends from a mating surface of either a trim panel 104 or a door module 102 to engaging element 220 and may fit into a portion of preferably V-shaped slot 310 of receiver 300. The engaging element 220 is preferably disposed at a distal end of neck 210, with the proximal end of the neck 210 located at the mating surface of the trim panel 104 or door module 102.

The bearing surface 124 of engaging element 220 may engage bearing surface 122 of receiver when hook 200 is assembled onto receiver 300. Moreover, bearing surface 122 may be directed substantially toward the mating surface from which neck 210 extends.

Locking element 230 of hook 200 may serve as a male component of detent mechanism 130. Locking element 230 may include a solid protruding element, a cantilevered tab, a spring-loaded tab, and/or a spring loaded member. While the embodiment shown in FIGS. 2-4 shows a protruding locking element 230 disposed on hook 200, and a corresponding recess 320 disposed on receiver 300, in other embodiments, this arrangement could be reversed while remaining within the scope of the present invention.

The process of assembling hook 200 to receiver 300 in accordance with one embodiment of the invention is now described. In the following, the movement of hook 200 and receiver 300 is described. It is understood that hook 200 and receiver 300 are generally coupled to respective components to be assembled, such as trim panel 104 and door module 102. However, for the sake of simplicity, the pertinent assembly operation is described in terms of only the hook 200 and receiver 300.

Hook 200 may be brought to a suitable approach location near receiver 300. Hook 200 may then be moved toward and into engagement with receiver 300. Chamfered flanges 202 of hook 200 may engage the chamfered flanges 302 of receiver 302 to enable the hook 200 to be appropriately guided into and centered with respect to receiver 300. Upon advancing hook 200 further onto receiver 300, V-shaped slot 310 may guide the V-shaped neck 210 of hook 200 into proper position. As the assembly operation nears completion, locking element 230 may initially engage a portion of bearing surface 122 just above recess 330. Upon advancing hook 200 still further onto receiver 300, locking element 230 preferably engages recess 330, thereby securing the assembly of hook 200 to receiver 300, and enabling bearing surfaces 122 and 124 to experience substantially complete surface contact with one another.

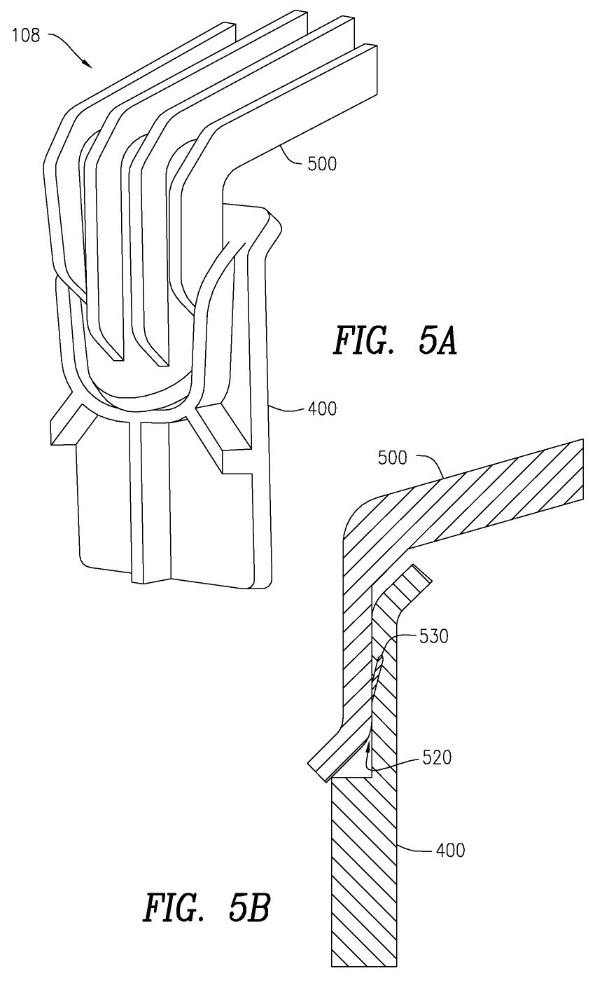

Attention is now directed to the embodiment of FIGS. 5-7. In the following, the various parts of hook 500 and receiver 400 are introduced. Thereafter, a selection of the parts are described in greater detail. Subsequently, a description of the interaction of various features of the hook 500 and receiver 400 during assembly of fastening device 108 is provided.

FIG. 5A is a perspective view of a fastening device 108 in accordance with one or more embodiments of the present invention; and FIG. 5B is a partially sectional and partially elevational view of the fastening device 108 of FIG. 5A. Fastening device 108 may include hook 500 and receiver 400, which may engage one another at bearing interface 520. Fastening device 108 may further include tension element 530 (FIG. 5B) to aid in securing hook 200 to receiver 300 at bearing interface 520.

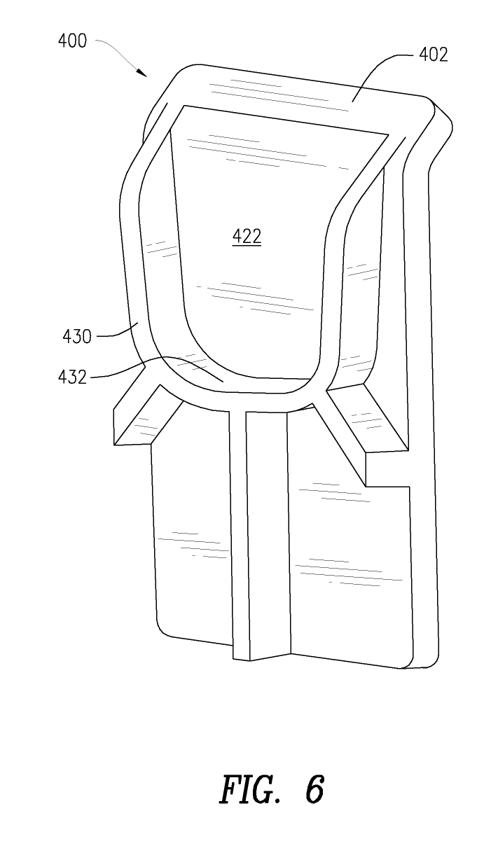

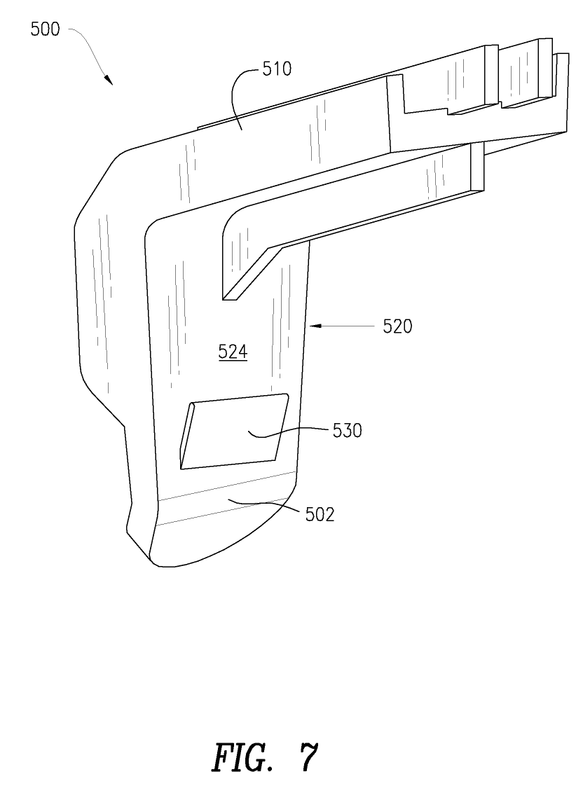

FIG. 6 is a perspective view of receiver 400 of the fastening device 108 of FIG. 5. Receiver 400 may include one or more chamfered flanges 402, bearing surface 422, and, engagement ridge 430, which may in turn include bottom edge 432. FIG. 7 is a perspective view of hook 500 of fastening device 108 of FIG. 5. Hook 500 may include neck 510, engaging element 520, which may in turn include bearing surface 524, chamfered flange (chamfered leading edge) 502, and/or tension element 530.

Chamfered flange 402 may include a curvature suitable for guiding chamfered leading edge 502 of hook 500 during assembly of hook 500 to receiver 400. Bearing surface 422 is preferably operable to engage bearing surface 524 of hook 500 to form bearing interface 520. Engagement ridge 430 is preferably configured to encase the leading edge of engagement element upon the advancement thereof along bearing surface 422. Bottom edge 432 of engagement ridge 430 is preferably operable to establish the limits of advancement of engaging element 520 along bearing surface 422 of receiver 400.

Turning to FIG. 7, hook 500 may include neck 510 which preferably extends from a mating surface of either a trim panel 104 or a door module 102 to engaging element 520 which is preferably disposed at the distal end of neck 510. Engaging element 520 may include bearing surface 524 which is preferably operable to engage bearing surface 422 of receiver 400. Engaging element 520 may further include tension element 520 which may springingly extend out from bearing surface 524 and may be operable to bias against bearing surface 422 of receiver 400 to oppose slack between bearing surfaces 524 and 422 and to thereby secure the assembly of hook 500 to receiver 400.

Tension element 530 may include a cantilevered tab, a spring-loaded tab, and/or a spring loaded member. In some embodiments, the spring bias of tension element 530 may be provided by a linear spring and/or a rotational spring.

The process of assembling hook 500 to receiver 400 is discussed in the following. Hook 500 may be brought to a suitable approach location near receiver 400. Hook 500 may then be moved toward and into engagement with receiver 400. Initial contact between hook 500 and receiver 400 may include chamfered leading edge 502 of hook 500 engaging chamfered flange 402 of receiver 400 to enable hook 400 to be suitably guided into receiver 400 while avoiding jamming during assembly.

As assembly progresses, the sides of engagement element 520 of hook 500 may engage engagement ridge 430 which may serve to further guide the motion of hook 500 and to center hook 500 with respect to receiver 400. As assembly progresses still further, the leading edge of engagement element 520 may approach and ultimately contact the bottom edge 432 of engagement ridge 430. Engagement ridge 430 may thereby establish the limit of travel of hook 500 with respect to receiver 400.

Once fully assembled, tension element 530 is preferably partially deflected, thereby imparting a biasing force against bearing surface 422 of receiver 400, which is preferably operable to secure the attachment of hook 500 to receiver 400. The biasing force of tension element 530 may be operable to oppose slack between bearing surfaces 524 and 422. Otherwise stated, force from tension element 530 may be operable to maintain force between bearing surfaces 524 and 422 even if bearing surfaces 524 and 422 experience some degree of physical separation. The tension force may therefore be operable to maintain suitable contact between the mating surfaces corresponding to the respective bearing surfaces 524 and 422, even if bearing surfaces 524 and 422 become separated. Thus, the tension force is preferably operable to compensate for a separation distance or gap which may arise from build variation in hook 500 and/or receiver 400, and any deformation arising in these parts over time.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A fastening mechanism for coupling a trim panel to a door module, comprising:
a hook disposed on a first mating surface of one of the door panel and the door module, the hook including a V-shaped neck extending away from the first mating surface, and an engaging element disposed at a distal end of the neck, the engaging element including a first bearing surface directed substantially toward the first mating surface; and
a receiver disposed on a second mating surface of the other of the door panel and the door module, the receiver including a V-shaped slot operable to receive the V-shaped neck of the hook and a second bearing surface operable to engage the first bearing surface of the hook and to prevent separation of the first and second mating surfaces.

2. The fastening mechanism of claim 1 further comprising a detent mechanism operable to secure an attachment of the hook to the receiver.

3. The fastening mechanism of claim 2 wherein the detent mechanism comprises:
a locking element disposed on one of the hook and the receiver; and
a recess corresponding to the locking element disposed on the other of the hook and the receiver.

4. The fastening mechanism of claim 1 wherein the neck and the engaging element of the hook are integrally formed.

5. The fastening mechanism of claim 3 wherein the locking element includes one or more of: a solid protrusion; a tang; and a cantilevered spring tab.

6. The fastening mechanism of claim 3 wherein the locking element is a cantilevered tab.

7. The fastening mechanism of claim 6 wherein the cantilevered tab is anchored on one of the hook and receiver.

8. The fastening mechanism of claim 7 wherein the cantilevered tab is operable to engage a recess in the other of the hook and the receiver.

9. A fastening mechanism for coupling a trim panel to a door module, comprising:
a hook disposed on a first mating surface of one of the door panel and the door module, the hook including a neck extending away from the first mating surface and an engaging element disposed at a distal end of the neck, the engaging element including a first bearing surface directed substantially toward the first mating surface and a tension element springingly extending from the first bearing surface; and
a receiver disposed on a second mating surface of the other of the door panel and the door module, the receiver including a second bearing surface directed substantially toward the second mating surface and being operable to engage the first bearing surface of the hook.

10. The fastening mechanism of claim 9 wherein the tension element is operable to bias against the second bearing surface of the receiver and oppose slack between the first and second bearing surfaces.

11. The fastening mechanism of claim 9 wherein the tension element is a cantilevered tab.

12. The fastening mechanism of claim 9 wherein the tension element is one of the group consisting of: a cantilevered tab, a spring-loaded tab; and a spring loaded member.

13. The fastening mechanism of claim 9 wherein the engagement element is a spring-loaded member.

14. The fastening mechanism of claim 13 wherein the spring-loaded member is springingly biased by one of a linear spring and a rotational spring.

15. A method fastening a trim panel to a door module, comprising:
disposing a hook on a first mating surface of one of the door panel and the door module, the hook including a neck extending away from the first mating surface and an engaging element disposed at a distal end of the neck, the engaging element including a first bearing surface directed substantially toward the first mating surface and a tension element springingly extending from the first bearing surface;
disposing a receiver on a second mating surface of the other of the door panel and the door module, the receiver including a second bearing surface directed substantially toward the second mating surface and being operable to engage the first bearing surface of the hook;
causing the tension element to bias against the second bearing surface of the receiver and fill any gap arising between the first and second bearing surfaces.

16. The method of claim 15 further comprising:
springingly biasing the tension element using one of a linear spring and a rotational spring.
